(19) United States
(12) Patent Application Publication
(10) Pub. No.: US 2013/0297145 A1
(43) Pub. Date: Nov. 7, 2013

(54) BRAKE CONTROL APPARATUS

(71) Applicant: ADVICS CO. LTD., Kariya-city (JP)

(72) Inventors: Jun SHINOZAKI, Obu-shi (JP); Koichi KOKUBO, Nagoya-shi (JP)

(73) Assignee: ADVICS CO. LTD., Kariya-city (JP)

(21) Appl. No.: 13/871,458

(22) Filed: Apr. 26, 2013

(30) Foreign Application Priority Data
May 1, 2012 (JP) 2012-104367

(51) Int. Cl. B60T 17/22

(52) U.S. Cl. CPC B60T 17/22
USPC 701/34.4

(57) ABSTRACT

An brake control apparatus includes a reference temperature acquiring unit which acquires a reference temperature correlating with a fluid temperature of a vehicle; an offset amount update unit which increases an offset amount with respect to the reference temperature of the fluid temperature depending on a lapsed time from the starting of the vehicle; and a fluid temperature estimation unit which estimates the fluid temperature by applying the offset amount to the reference temperature.

### TECHNOLOGICAL FIELD

The present invention relates to a brake control apparatus which controls a braking force given to a vehicle.

### BACKGROUND DISCUSSION

As an example of a brake control apparatus, for example, an invention is disclosed in JP-A-11-348765. In the apparatus disclosed in JP-A-11-348765, whether or not a temperature of brake fluid is low is determined by using an outside air temperature sensor or the like. Then, reduction of control frequency of a booster negative-pressure control is intended by supplying a large booster negative pressure to a negative-pressure chamber only when the temperature of the brake fluid is low.

However, in the apparatus disclosed in JP-A-11-348765, whether or not the temperature of the brake fluid is low is determined by using the temperature sensor such as the outside air temperature sensor which is existed in the vehicle. Thus, precision of temperature estimation of the brake fluid may be deteriorated from an external factor such as a traveling state of the vehicle.

### SUMMARY

A brake control apparatus comprises a reference temperature acquiring unit which acquires a reference temperature correlating with a fluid temperature of a vehicle; an offset amount update unit which increases an offset amount with respect to the reference temperature of the fluid temperature depending on a lapsed time from the starting of the vehicle; and a fluid temperature estimation unit which estimates the fluid temperature by applying the offset amount to the reference temperature.

### BRIEF DESCRIPTION OF THE DRAWINGS

FIG. 1 is a configuration view illustrating an example of a configuration of a braking apparatus to which the invention is applicable.

FIG. 2 is a partial cross-sectional view illustrating an arrangement example of a brake ECU 60 and a pressure regulator 43.

FIG. 3 is a block diagram illustrating an example of a control block relating to estimation of a fluid temperature Tf.

FIG. 4 is an explanatory view illustrating an example of relationship between an ECU temperature difference ΔTe and a starting temperature difference ΔTef.

FIG. 5 is an explanatory view illustrating an example of relationship between the starting temperature difference ΔTef and a starting offset amount Q0.

FIG. 6 is an explanatory view illustrating an example of a temporal change of an offset amount Qoff in cold start.

FIG. 7 is an explanatory view illustrating an example of the temporal change of the offset amount Qoff in hot start.

FIG. 8 is a flowchart illustrating an example of a procedure relating to the estimation of the fluid temperature Tf.

FIG. 9 is an explanatory view illustrating an example of cold start characteristics.

FIG. 10 is an explanatory view illustrating an example of hot start characteristics.

FIG. 11 is a timing chart for explaining estimation of the fluid temperature Tf of the embodiment by a comparative example.

FIG. 12 is a timing chart for explaining estimation of the fluid temperature Tf according to the embodiment.

FIG. 13 is an explanatory view illustrating an example of relationship between an operation time Tw and a correction amount QH of the offset amount Qoff.

### DETAILED DESCRIPTION OF THE INVENTION

Hereinafter, an embodiment of the invention will be described, based on the drawings. In addition, each of the drawings is a schematic view and is not intended to define dimensions of a detailed structure.

(i) Configuration of Braking Apparatus 10

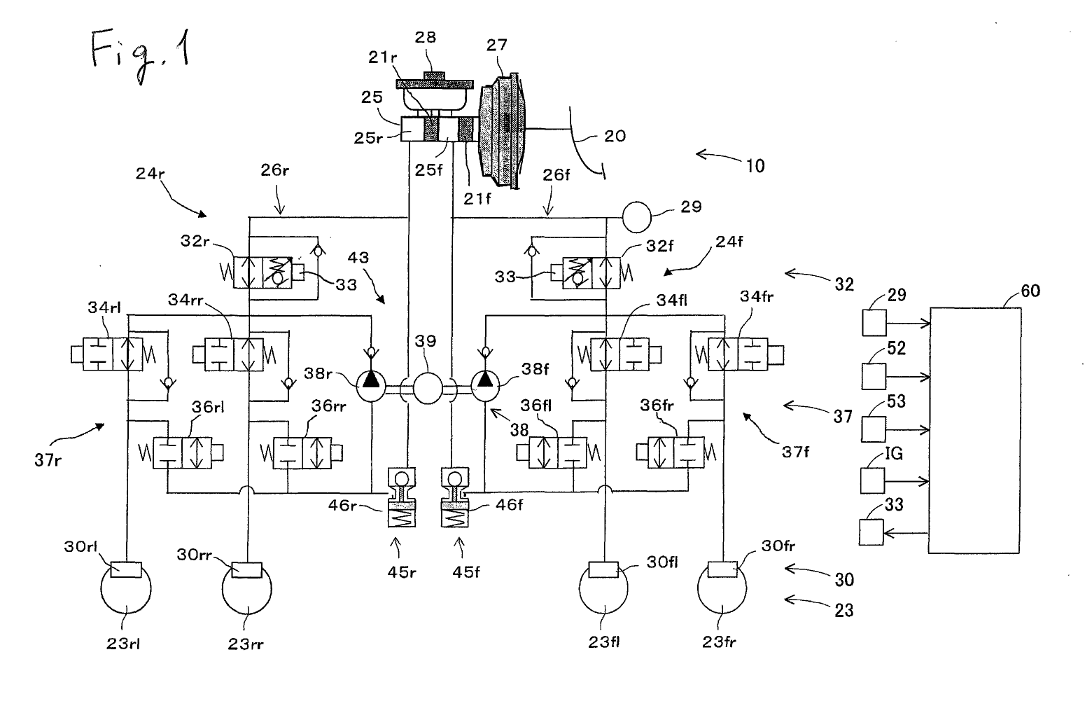

FIG. 1 is a constitution view illustrating an example of a configuration of a braking apparatus to which the invention is applicable. A braking apparatus 10 of the embodiment includes a front wheel brake system 24f and a rear wheel brake system 24r having a common configuration provided to separate from each other. In addition, a driver operates a brake pedal 20 and then a braking force can be applied to a vehicle wheel 23. Since the front wheel brake system 24f and the rear wheel brake system 24r have the same configuration part and operation each other, in the specification, “f” or “r” which distinguishes a front wheel and a rear wheel is given to an end of a reference numeral of corresponding configuration part, and then “I” or “r” which distinguishes the left and right is given. In addition, when the configuration part is illustrated without distinguishing the front, rear, left and right, only corresponding reference numeral is given.

The braking apparatus 10 mainly includes a brake pedal 20, a master cylinder 25, a booster 27, a pressure regulator 43, a wheel cylinder 30 and a brake ECU 60. The brake ECU 60 corresponds to “a brake control apparatus”. In addition, the braking apparatus 10 includes various sensors such as a stroke sensor 52, a temperature sensor 53 and a fluid pressure sensor 29. The sensors are connected with the brake ECU 60.

The wheel cylinder 30 has a wheel cylinder 30fl provided on a front-left wheel 23fl, a wheel cylinder 30fr provided on a front-right wheel 23fr, a wheel cylinder 30rl provided on a rear-left wheel 23r1 and a wheel cylinder 30rr provided on a rear-right wheel 23rr.

The master cylinder 25 is so-called a known dual master cylinder and a master pistons 21f and 21r generating master pressure in two fluid pressure chambers 25f and 25r, respectively are slidably fitted into the master cylinder 25. Brake fluid (hereinafter, simply referred to as “fluid”) is delivered from the fluid pressure chambers 25f and 25r to pipes 26f and 26r depending on a moving amount of the master pistons 21f and 21r by sliding of the master pistons 21f and 21r. The fluid pressure chamber 25f supplies the fluid to the front wheel brake system 24f and the fluid pressure chamber 25r supplies the fluid to the rear wheel brake system 24r. In addition, the master cylinder 25 has a reservoir 28 in which the fluid is stored. The reservoir 28 replenishes the fluid to the fluid pressure chambers 25f and 25r of the master cylinder 25.

The booster 27 is disposed between the brake pedal 20 and the master cylinder 25. The booster 27 is a known negative pressure booster and is a booster using a negative pressure which is generated inside an intake pipe of an engine (not illustrated). In addition, the booster 27 is not an essential configuration element according to the invention.

The brake pedal 20 has the stroke sensor 52. The stroke sensor 52 outputs a detection signal to the brake ECU 60 depending on a pedal stroke amount of the brake pedal 20. The brake ECU 60 calculates a necessary braking force (a target braking force) depending on a detection result of the stroke sensor 52. The relationship between the pedal stroke amount and the target braking force is stored in a memory in advance by a map, a table or a relational expression.

The pressure regulator 43 is provided between the master cylinder 25 and the wheel cylinder 30. The pressure regulator 43 has a proportional control valve 32, an ABS control valve 37, a pump 38 and a motor 39, and can regulates a wheel cylinder pressure. As illustrated in the same view, the front wheel brake system 24f has a proportional control valve 32f, an ABS control valve 37f and a pump 38f, and the rear wheel brake system 24r has a proportional control valve 32r, an ABS control valve 37r and a pump 38r. An input port of the proportional control valve 32f is connected with the fluid pressure chamber 25f of the master cylinder 25 via the pipe 26f and an input port of the proportional control valve 32r is connected with the fluid pressure chamber 25r of the master cylinder 25 via the pipe 26r.

For example, the proportional control valve 32 can use a known solenoid electromagnetic valve. The proportional control valve 32 can control a pressure difference between the input port and the output port by changing a control current applied to a linear solenoid 33. The proportional control valve 32 is an open type proportional control valve and the input port and the output port communicate each other when the control current is not applied to the linear solenoid 33. In addition, a check valve, which permits fluid flow from the input port to the output port and restricts the fluid flow in a reverse direction thereof, is arranged between the input port and the output port of the proportional control valve 32f. Similarly, a check valve, which permits fluid flow from the input port to the output port and restricts the fluid flow in a reverse direction thereof, is arranged between the input port and the output port of the proportional control valve 32r.

For example, the proportional control valve 32 can be used in a known vehicle posture stability control. The vehicle posture stability control gives the braking force to front wheels 23fl and 23fr in oversteering and gives the braking force to rear wheels 23r1 and 23rr in understeering. Accordingly, skidding of the vehicle is suppressed. The brake ECU 60 adjusts the braking force being given to the front wheels 23fl and 23fr and the rear wheels 23r1 and 23rr by controlling the driving of the pump 38 or controlling the control current applied to each linear solenoid 33 of the proportional control valves 32f and 32r.

The pipe 26f connected with the output port of the proportional control valve 32f is branched and is connected with the wheel cylinders 30fl and 30fr via the ABS control valve 37f, respectively. Similarly, the pipe 26r connected with the output port of the proportional control valve 32r is branched and is connected with the wheel cylinders 30rl and 30rr via the ABS control valve 37r, respectively.

The ABS control valve 37f has holding valves 34fl and 34fr, and pressure reducing valves 36fl and 36fr. The ABS control valve 37r has holding valves 34rl and 34rr, and pressure reducing valves 36r1 and 36rr. Here, the ABS control valve 37 in the front-left wheel 23fl in four wheels is described as an example; however, the other wheels also have the same configuration. In addition, the brake ECU 60 controls the motor 39 and operates the pump 38 during the ABS control.

The holding valve 34fl is a normally open-type electromagnetic valve which communicates or cuts off the pipe connecting between the fluid pressure chamber 25f of the master cylinder 25 and the wheel cylinder 30fl. In the holding valve 34fl, a check valve, which permits fluid flow from the wheel cylinder 30fl to the master cylinder 25 and restricts the fluid flow in the reverse direction, is arranged. The pressure reducing valve 36fl is a normally close-type electromagnetic valve which communicates or cuts off the pipe connecting between the wheel cylinder 30fl and a pressure responding valve 45f.

The brake ECU 60 excites or does not excites the holding valve 34fl and the pressure reducing valve 36fl, respectively and then the holding valve 34fl and the pressure reducing valve 36fl are open and closed, respectively. Accordingly, the ABS control can be performed. The ABS control has a pressure increasing mode, a holding mode and a pressure reducing mode.

In the pressure increasing mode, the holding valve 34fl is in an open state and the pressure reducing valve 36fl is in a closed state. In the holding mode, the holding valve 34fl and the pressure reducing valve 36fl are in the closed state, respectively. In the pressure reducing mode, the holding valve 34fl is in the closed state and the pressure reducing valve 36fl is the open state. Accordingly, lock of the vehicle wheel 23fl is released by increasing and decreasing the braking force given to the front wheel 23fl, and then the skidding of the vehicle or the like can be prevented.

The pump 38 is driven by the motor 39. A discharge port of the pump 38f is connected with the pipe which connects the output port of the proportional control valve 32f and each input port of the holding valves 34fl and 34fr via the check valve preventing the fluid flow to the discharge port. Similarly, a discharge port of the pump 38r is connected with the pipe which connects the output port of the proportional control valve 32r and each input port of the holding valves 34rl and 34rr via the check valve preventing the fluid flow to the discharge port.

An intake port of the pump 38f is connected with the input port of the proportional control valve 32f via a pressure responding valve 45f communicating with the output ports of the pressure reducing valves 36fl and 36fr. Similarly, an intake port of the pump 38r is connected with the input port of the proportional control valve 32r via a pressure responding valve 45r communicating with the output ports of the pressure reducing valves 36r1 and 36rr.

The pressure responding valves 45f and 45r include reservoirs 46f and 46r in which casings having bottoms are closed by using pistons biased by compression springs. The pressure responding valves 45f and 45r are open when there is no fluid any more in the reservoirs 46f and 46r. Accordingly, the intake ports of the pumps 38f and 38r communicate with the fluid pressure chambers 25f and 25r of the master cylinder 25. In addition, the pressure responding valves 45f and 45r can store temporally the fluid of the ABS control valves 37f and 37r.

In the brake ECU 60, various detection signals are input from the stroke sensor 52, the fluid pressure sensor 29, a vehicle wheel speed sensor (not illustrated) detecting each vehicle wheel speed of the vehicle wheel 23 or the like. Then, the brake ECU 60 applies the control current to the linear solenoid 33 of the proportional control valve 32 so that the fluid pressure of the fluid supplying from the pump 38 to the wheel cylinder 30 is a control fluid pressure, based on a target braking force. Accordingly, the braking apparatus 10 can give a desired fluid pressure braking force to the vehicle wheel 23. In addition, the brake ECU 60 can perform a so-called vehicle stability control such as the ABS control and the vehicle posture stability control as required. In addition, the brake ECU 60 feedbacks the fluid pressure detected in the fluid pressure sensor 29 and can perform the feedback control. Accordingly, the wheel cylinder pressure of the wheel cylinder 30 can be controlled more precisely.

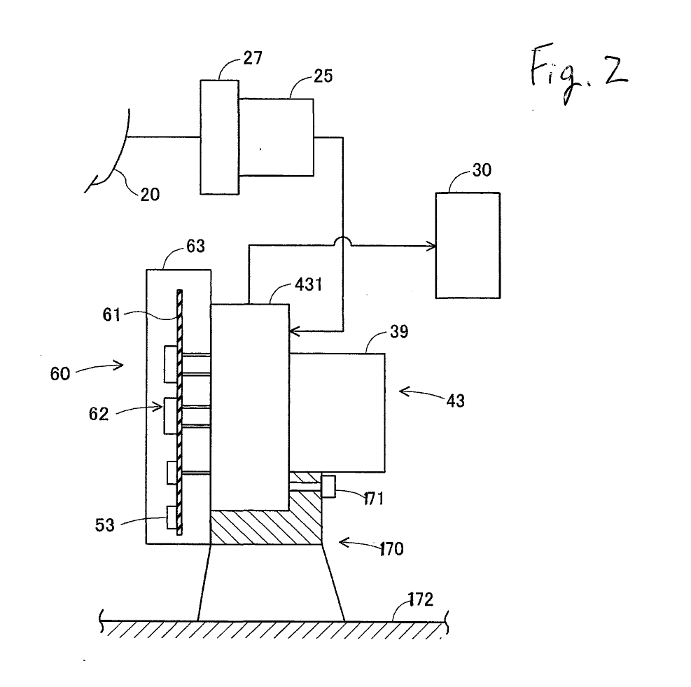

FIG. 2 is a partial cross-sectional view illustrating an arrangement example of the brake ECU 60 and the pressure regulator 43. The pressure regulator 43 is housed in a case 431 besides the motor 39. The motor 39 is arranged on one end side of the casing 431 and the brake ECU 60 is arranged on the other end side of the casing 431. The brake ECU 60 is configured to have a print substrate 61 on which a plurality of electronic parts 62 are mounted. The electronic parts 62 are configured of a microcomputer or a power device. The power device is a device which configures electronic valves 32, 34 and 36 of the pressure regulator 43 or a driving circuit of the motor 39.

The print substrate 61 has the temperature sensor 53 apart from the power device which has a large heating amount generated during driving among the electronic parts 62. For example, the temperature sensor 53 can use a known thermistor. For example, the thermistor can use a NTC thermistor in which a resistance value decreases as the temperature increases. In this case, the brake ECU 60 can detect the temperature of the substrate of the print substrate 61 from a resistance value of the temperature sensor 53. The print substrate 61, the electronic parts 62 and the temperature sensor 53 are resin molded inside a case 63.

The case 431 is fixed to a base stand 170 by using a bolt 171 and the base stand 170 is fixed to a frame 172 of the vehicle. In addition, in the same view, each device of the braking apparatus 10 is schematically illustrated and detailed description such as a pipe will be omitted.

(ii) Estimation of Fluid Temperature Tf

In the pressure regulator 43, characteristics illustrating relationship between the pressure difference generated in the proportional control valve 32 and the control current applying to the linear solenoid 33 are changed by the fluid temperature Tf which is relieved from the proportional control valve 32. Then, in the embodiment, the fluid temperature Tf of the fluid discharged from the pump 38 is estimated and the control current applying to the linear solenoid 33 is corrected. Accordingly, precision of the pressure regulation in the pressure regulator 43 is improved.

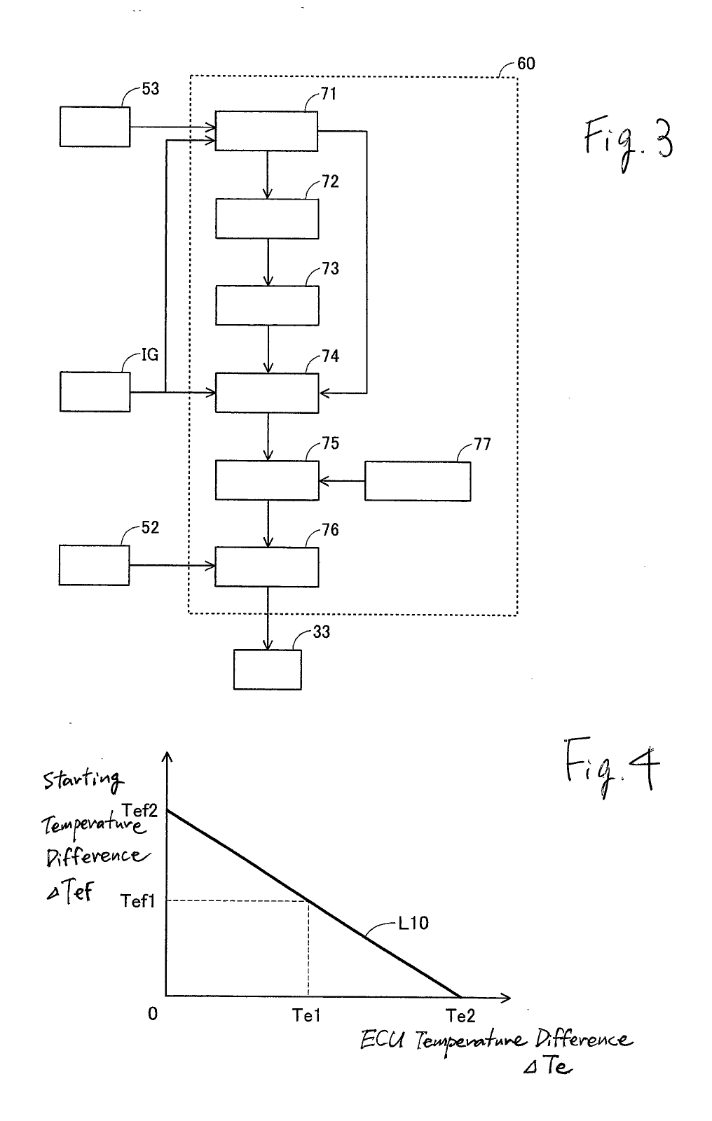

FIG. 3 is a block diagram illustrating an example of a control block relating to estimation of the fluid temperature Tf. The brake ECU 60, when taken as a control block, has a reference temperature acquiring section (unit) 71, a starting temperature difference estimation section (unit) 72, a starting offset amount setting section (uint) 73, an offset amount update section (unit) 74, a fluid temperature estimation section (unit) 75, a pressure regulation control section (unit) 76 and an offset amount correction section (unit) 77.

[Reference Temperature Acquiring Section 71]

The reference temperature acquiring section 71 acquires a reference temperature correlating with the fluid temperature Tf of the vehicle. When an ignition switch IG is turned ON state from OFF state and the brake ECU 60 starts, the reference temperature acquiring section 71 detects the resistance value of the temperature sensor 53 for every lapse of predetermined time. Then, a substrate temperature of the print substrate 61 is acquired from the detected resistance value of the temperature sensor 53. The relationship between the resistance value of the temperature sensor 53 and the substrate temperature of the print substrate 61 is stored in the memory of the brake ECU 60 in advance by the map, the table or the relational expression.

The substrate temperature of the print substrate 61 corresponds to “the reference temperature” and is also referred to as an ECU temperature Te below. In addition, when the ignition switch IG is turned OFF state from ON state and the control is finished by the brake ECU 60, the reference temperature acquiring section 71 stores the ECU temperature Te when finishing the brake ECU 60. At this time, the ECU temperature Te is a stored value of the ECU temperature Te.

When starting the vehicle, the ECU temperature Te and the fluid temperature Tf are increased by heating of a heat generation section (for example, the engine) of the vehicle. In addition, the ECU temperature Te is also increased by heating of the electronic parts 62. When the time has sufficiently lapsed from the starting of the vehicle, the ECU temperature Te and the fluid temperature Tf are saturated and become constant.

Here, when the driver operates (hereinafter, referred to as a brake operation) the brake pedal 20, since the motor 39 and the proportional control valve 32 or the like is driven, the ECU temperature Te is increased temporarily. In addition, the pump 38 acts on the fluid so that the fluid temperature Tf is also increased temporarily. When the driver finishes the brake operation, the ECU temperature Te and the fluid temperature Tf are decreased and then return to the temperatures before the brake is operated.

For example, since cooling effect by wind during travel is small in low-speed traveling such as traffic congestion, the ECU temperature Te and the fluid temperature Tf are increased in the same extent. As described above, since the fluid temperature Tf and the ECU temperature Te (the reference temperature) are correlated to each other, the offset amount Qoff is set with respect to the ECU temperature Te and the offset amount Qoff is applied to the ECU temperature Te. Accordingly, the fluid temperature Tf can be estimated.

Here, since specific heat of the brake ECU 60 and the fluid are different from each other, the temperature difference between the ECU temperature Te and the fluid temperature Tf is increased depending on the lapsed time from the starting of the vehicle, and the ECU temperature Te and the fluid temperature Tf are substantially maximum when the ECU temperature Te and the fluid temperature Tf are saturated. Accordingly, when the ECU temperature Te and the fluid temperature Tf are saturated, the maximum offset amount Qmax corresponding to the maximum temperature difference may be applied to the ECU temperature Te.

However, the offset amount Qoff with respect to the ECU temperature Te (the reference temperature) is smaller than the maximum offset amount Qmax until a predetermined time is lapsed from the starting of the brake ECU 60. Thus, when the fluid temperature Tf is estimated by applying a constant offset amount Qoff from the starting of the brake ECU 60, an estimated error of the fluid temperature Tf is increased. Then, in the embodiment, the offset amount Qoff is increased to the maximum offset amount Qmax depending on the time lapsed from the starting of the brake ECU 60. In addition, the offset amount Qoff when starting the vehicle is referred to as the offset amount Q0 when starting.

[Starting Temperature Difference Estimation Section 72]

The starting temperature difference estimation section 72 estimates a starting temperature difference ΔTef that is the temperature difference between the ECU temperature Te (the reference temperature) and the fluid temperature Tf when starting the vehicle. When the brake ECU 60 is started, the starting temperature difference estimation section 72 subtracts the value of the ECU temperature Te when starting from the stored value of the ECU temperature Te and outputs the ECU temperature difference ΔTe. The value of the ECU temperature Te when starting is referred to as the ECU temperature Te that is initially detected by the reference temperature acquiring section 71 after the brake ECU 60 is started.

FIG. 4 is an explanatory view illustrating an example of relationship between the ECU temperature difference ΔTe and the starting temperature difference ΔTef. The lateral axis illustrates the ECU temperature difference ΔTe and the vertical axis illustrates the starting temperature difference ΔTef. A straight line L10 illustrates relationship between the ECU temperature difference ΔTe and the starting temperature difference ΔTef. For example, when the ECU temperature difference ΔTe is Te1, the starting temperature difference ΔTef is Tef1. The relationship illustrated in the straight line L10 is stored in the memory in advance by the map, the table or the relational expression.

When the ECU temperature difference ΔTe is 0, the starting temperature difference ΔTef is Tef2 and becomes the maximum thereof. In this case, the time lapsed from the finishing of the brake ECU 60 to the starting is short and the ECU temperature Te and the fluid temperature Tf are separated from each other. Meanwhile, when the ECU temperature difference ΔTe is Te2, the starting temperature difference ΔTef is 0 and becomes the minimum thereof. In this case, the time lapsed from the finishing of the brake ECU 60 to the starting is sufficiently long. In addition, the ECU temperature Te and the fluid temperature Tf substantially accord to each other. In other words, it is considered that the ECU temperature Te, the fluid temperature Tf and temperature of the motor 39 or the like is substantially uniform.

[Starting Offset Amount Setting Section 73]

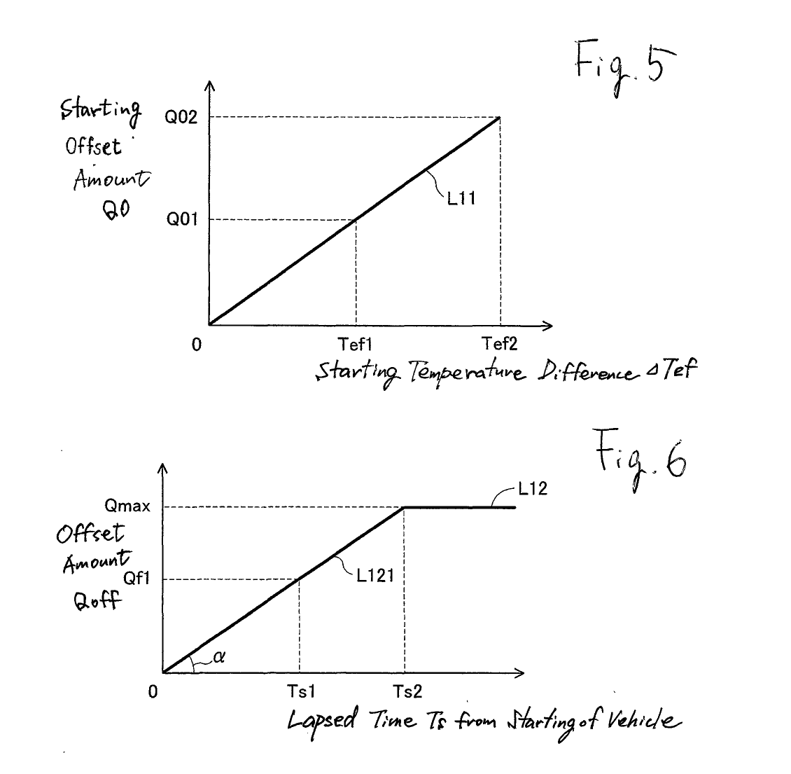

The starting offset amount setting section 73 sets the starting offset amount Q0 depending on the starting temperature difference ΔTef which is estimated by the starting temperature difference estimation section 72. FIG. 5 is an explanatory view illustrating an example of relationship between the starting temperature difference ΔTef and the starting offset amount Q0. The lateral axis illustrates the starting temperature difference ΔTef and the vertical axis illustrates the starting offset amount Q0. A straight line L11 illustrates relationship between the starting temperature difference ΔTef and the starting offset amount Q0. For example, when the starting temperature difference ΔTef is Tef1, the starting offset amount Q0 is Q01. The relationship illustrated in the straight line L11 is stored in the memory in advance by the map, the table or the relational expression.

When the starting temperature difference ΔTef is 0, the starting offset amount Q0 is 0 and becomes the minimum thereof. In this case, the time lapsed from the finishing of the brake ECU 60 to the starting is sufficiently long and, the ECU temperature Te and the fluid temperature Tf substantially accord to each other. Accordingly, the starting offset amount Q0 is 0. Meanwhile, when the starting temperature difference ΔTef is Tef2, the starting offset amount Q0 is Q02 and becomes the maximum thereof. In this case, the time lapsed from the finishing of the brake ECU 60 to the starting is short and the ECU temperature Te and the fluid temperature Tf are the most separated from each other. Accordingly, the starting offset amount Q0 is Q02 that is the maximum thereof.

[Offset Amount Update Section 74]

The offset amount update section 74 updates the offset amount Qoff of the fluid temperature Tf with respect to the ECU temperature Te (the reference temperature). The offset amount update section 74 increases the offset amount Qoff depending on a lapsed time Ts from the starting of the vehicle (the brake ECU 60). After the offset amount Qoff reaches the maximum offset amount Qmax, the offset amount Qoff is constant in the maximum offset amount Qmax. In addition, an increasing speed of the offset amount Qoff until the offset amount Qoff reaches the maximum offset amount Qmax is referred to as an offset amount increasing speed α and illustrates an increasing width of the offset amount Qoff per unit time.

FIG. 6 is an explanatory view illustrating an example of a temporal change of the offset amount Qoff in cold start. The lateral axis illustrates a lapsed time Ts from the starting of the vehicle and the vertical axis illustrates the offset amount Qoff. A curve L12 illustrates the temporal change of the offset amount Qoff. In the specification, the lapsed time from the finishing of the brake ECU 60 to the starting is sufficiently long and starting the vehicle (brake ECU 60) in a state where the ECU temperature Te and the fluid temperature Tf substantially accord to each other is referred to as the cold start.

As illustrated in the same view, when the brake ECU 60 starts, the offset amount Qoff is gradually increased from 0 and reaches to the maximum offset amount Qmax when the lapsed time Ts is Ts2 from the starting of the vehicle. After that, the offset amount Qoff is constant in the maximum offset amount Qmax. For example, the offset amount update section 74 adds a constant offset adding amount ΔQ to the offset amount Qoff depending on the lapsed time Ts from the starting of the vehicle. Accordingly, the offset amount Qoff can be increased according to a straight line portion L121. In the same view, when the lapsed time Ts is Ts1 from the starting of the vehicle, the offset amount Qoff becomes Of1.

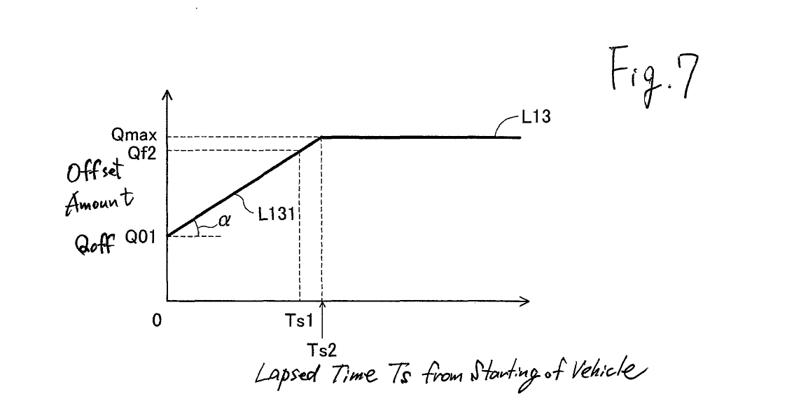

FIG. 7 is an explanatory view illustrating an example of the temporal change of the offset amount Qoff in hot start. The lateral axis illustrates the lapsed time Ts from the starting of the vehicle and the vertical axis illustrates the offset amount Qoff. A curve L13 illustrates the temporal change of the offset amount Qoff. In the specification, the lapsed time from the finishing of the brake ECU 60 to the starting is short and starting the vehicle (brake ECU 60) in a state where the ECU temperature Te and the fluid temperature Tf are separated from each other is referred to as the hot start.

In a case of the hot start illustrated in the same view, the offset amount Qoff when starting the brake ECU 60 is different from the case of the cold start illustrated in FIG. 6. Particularly, the offset amount Qoff when starting the brake ECU 60 is set to the offset amount Q0 when starting described above. For example, when the lapsed time Ts is Ts1 from the starting of the vehicle, the offset amount Qoff becomes Qf2. Qf2 is greater than Of1. In addition, the offset amount update section 74 can increase the offset amount Qoff according to a straight line portion L131 by using the same method as the case of the cold start.

In the embodiment, since the brake ECU 60 (the brake control apparatus) includes the starting temperature difference estimation section 72 and the starting offset amount setting section 73, the starting offset amount Q0 can be set according to the starting temperature difference ΔTef which is estimated in the starting temperature difference estimation section 72. Then, the offset amount update section 74 outputs the offset amount Qoff from the offset amount increasing speed α, the lapsed time Ts from the starting of the vehicle and the starting offset amount Q0. Accordingly, the offset amount Qoff can be updated according to the increase in the difference between both temperatures from the starting of the vehicle until the ECU temperature Te and the fluid temperature Tf are saturated. In addition, the precision of the estimation of the fluid temperature Tf can be improved.

[Fluid Temperature Estimation Section 75]

The fluid temperature estimation section 75 estimates the fluid temperature Tf by applying the offset amount Qoff to the ECU temperature Te (the reference temperature). Particularly, the fluid temperature estimation section 75 outputs the fluid temperature Tf by subtracting the offset amount Qoff, which is output in the offset amount update section 74, from the ECU temperature Te acquired in the reference temperature acquiring section 71.

[Pressure Regulation Control Section 76]

The pressure regulating control section 76 corrects the control current applying to the linear solenoid 33 by using the fluid temperature Tf which is output in the fluid temperature estimation section 75. The correction amount of the control current with respect to the fluid temperature Tf is stored in advance by the map, the table or the relational expression. In the pressure regulating control section 76, the pressure difference generated in the proportional control valve 32 can be changed according to the change of the fluid temperature Tf by applying the corrected control current to the linear solenoid 33. Thus, the precision of the pressure regulation of the pressure regulator 43 can be improved.

In the embodiment, the brake ECU 60 (the brake control apparatus) includes the offset amount update section 74 and the fluid temperature estimation section 75. The offset amount update section 74 increases the offset amount Qoff with respect to the ECU temperature Te (the reference temperature) of the fluid temperature Tf depending on the lapsed time Ts from the starting of the vehicle. Then, the fluid temperature estimation section 75 estimates the fluid temperature Tf by applying the offset amount Qoff to the ECU temperature Te (the reference temperature). Accordingly, the precision of the estimation of the fluid temperature Tf can be improved compared to the case where a constant offset amount is applied to the ECU temperature Te (the reference temperature) from the starting of the vehicle and the fluid temperature Tf is estimated.

In addition, since the brake ECU 60 (the brake control apparatus) includes the reference temperature acquiring section 71 which acquires the ECU temperature Te (the reference temperature) correlating with the fluid temperature Tf, the precision of the estimation of the fluid temperature Tf can be prevented from reducing due to an external factor such as the traveling state of the vehicle. In addition, it is not necessary to regulate the temperature characteristics for each vehicle and cost thereof can be reduced.

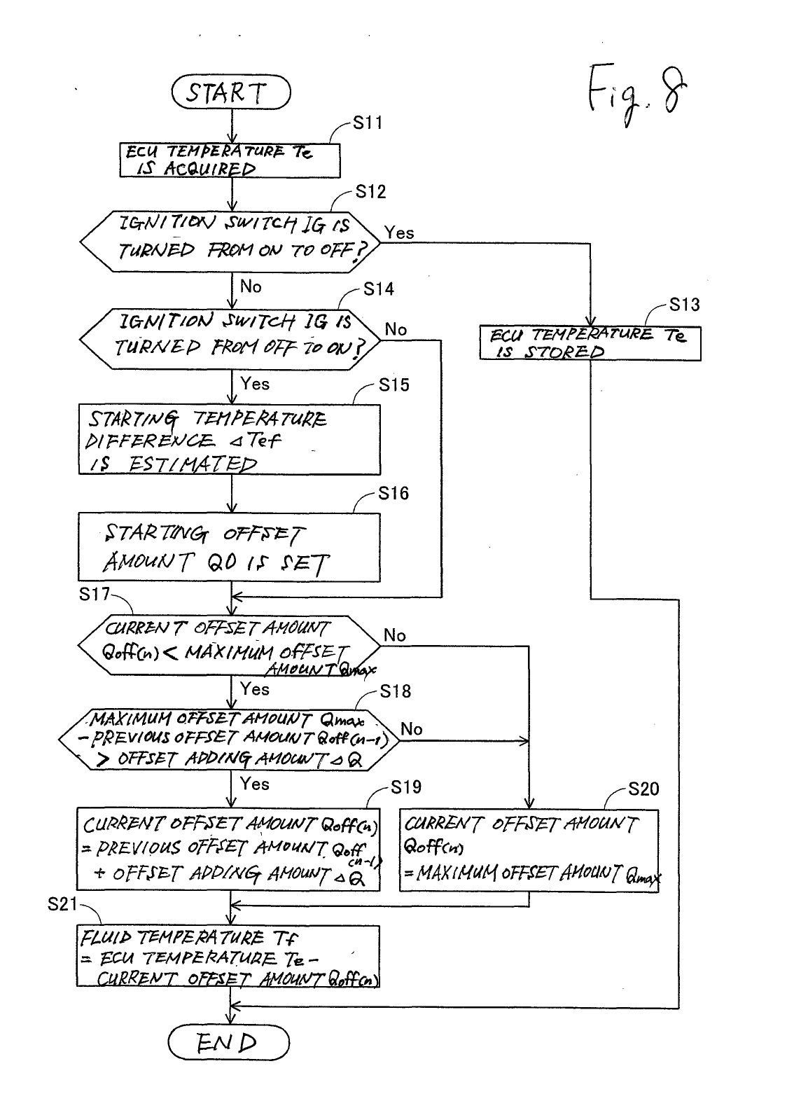

FIG. 8 is a flowchart illustrating an example of a procedure relating to the estimation of the fluid temperature Tf. The brake ECU 60 can perform the estimation of the fluid temperature Tf by executing a program stored in the memory. The estimation of the fluid temperature Tf is carried out repeatedly for every predetermined lapsed time.

First, in step S11, the ECU temperature Te is acquired in the reference temperature acquiring section 71. Next, in step S12, whether or not the ignition switch IG is turned OFF state from ON state is determined. In other words, whether or not the control is finished in the brake ECU 60 is determined. When the condition is satisfied (Yes), the process proceeds to step S13 and the ECU temperature Te when finishing the brake ECU 60 in the reference temperature acquiring section 71 is stored in the memory. Then, once, the routine is finished.

In step S12, when the condition is not satisfied (No), the process proceeds to step S14. In step S14, whether or not the ignition switch IG is turned ON state from OFF state is determined. In other words, whether or not the brake ECU 60 starts is determined. When the condition is satisfied (Yes), the process proceeds to steps S15 and S16. When the condition is not satisfied (No), the process proceeds to step S17.

In step S15, the starting temperature difference ΔTef that is the temperature difference between the ECU temperature Te and the fluid temperature Tf when starting is estimated in the starting temperature difference estimation section 72. Next, in step S16, the starting offset amount Q0 is set in the starting offset amount setting section 73.

In step S17, whether or not current offset amount Qoff(n) is smaller than the maximum offset amount Qmax is determined. The current offset amount Qoff(n) illustrates the offset amount Qoff which is processed current in the step. When the condition is satisfied (Yes), the process proceeds to step S18 and when the condition is not satisfied (No), the process proceeds to step S20. In step S18, whether or not a subtracted value, which subtracts the previous offset amount Qoff(n−1) from the maximum offset amount Qmax, is greater than the offset adding amount AQ is determined. The previous offset amount Qoff(n−1) illustrates the offset amount Qoff when the present step is processed in the previous step. When the condition is satisfied (Yes), the process proceeds to step S19 and the condition is not satisfied (No), the process proceeds to step S20.

In step S19, the current offset amount Qoff(n) is output by adding the offset adding amount ΔQ to the previous offset amount Qoff(n−1). Meanwhile, in step S20, the maximum offset amount Qmax is the current offset amount Qoff(n). Then, in step S21, the fluid temperature estimation section 75 outputs the fluid temperature Tf by subtracting the current offset amount Qoff(n) from the ECU temperature Te. In addition, the offset amount update section 74 carries out steps S17 to S20.

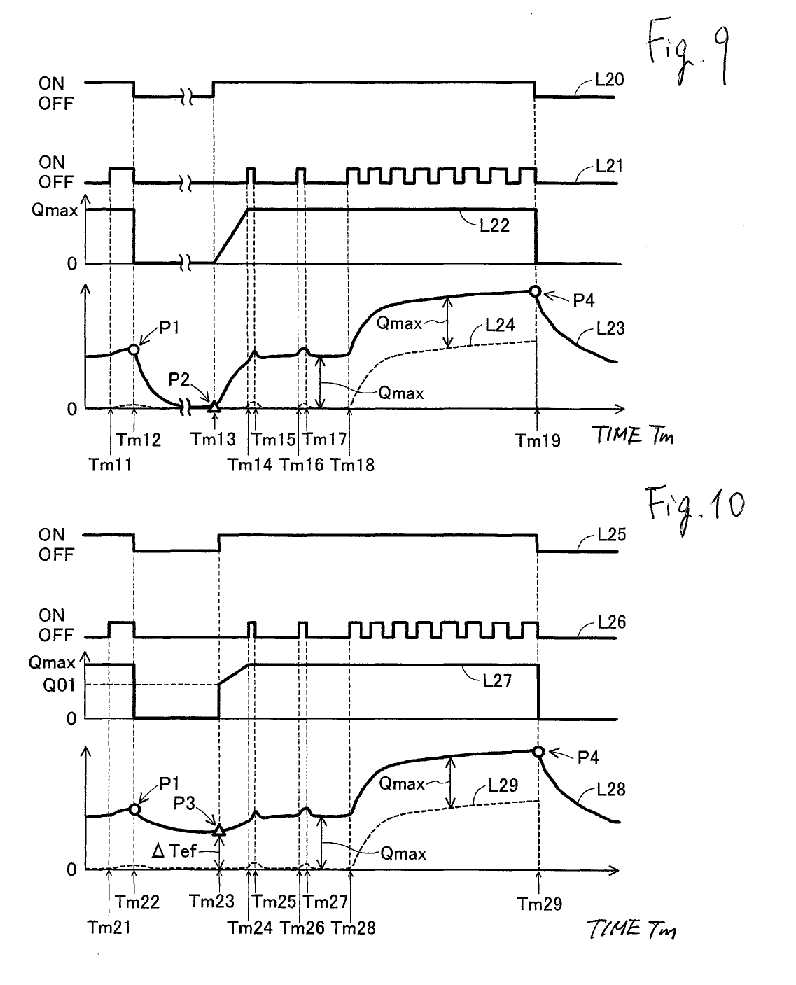

FIG. 9 is an explanatory view illustrating an example of the cold start characteristics. FIG. 10 is an explanatory view illustrating an example of the hot start characteristics. The lateral axis illustrates a time Tm. Curves L20 and L25 illustrate the state (ON or OFF) of the ignition switch IG, curves L21 and L26 illustrate the state (ON or OFF) of the brake operation. Curves L22 and L27 illustrate the offset amount Qoff, curves L23 and L28 illustrate the detected value of the ECU temperature Te, and curves L24 and L29 illustrate the estimated value of the fluid temperature Tf.

In FIG. 9, it is assumed that after the driver operates the brake from a time Tm11 to a time Tm12, the ignition switch IG is turned OFF. Thus, in the time Tm12, the reference temperature acquiring section 71 stores the ECU temperature Te when finishing the brake ECU 60 (P1 illustrated in the same view). In addition, in the same view, it is assumed that the driver turns ON the ignition switch IG in the time Tm13. In addition, time from the time Tm12 to the time Tm13 is sufficiently long.

Since the time lapsed from the finishing of the brake ECU 60 to the starting is sufficiently long, in the time Tm13, the starting temperature difference estimation section 72 estimates the temperature difference between the ECU temperature Te and the fluid temperature Tf is 0 (P2 illustrated in the same view). Thus, the starting offset amount setting section 73 sets 0 as the starting offset amount Q0. Then, the offset amount update section 74 gradually increases the offset amount Qoff from the time Tm13 to the time Tm14. In the time Tm14, the offset amount Qoff reaches the maximum offset amount Qmax. After the time Tm14, the offset amount Qoff is constant in the maximum offset amount Qmax (the curve L22).

Meanwhile, in FIG. 10, it is assumed that after the driver operates the brake from the time Tm21 to the time Tm22, the ignition switch IG is turned OFF and the driver turns ON the ignition switch IG in the time Tm23. In addition, the time from the time Tm22 to the time Tm23 is short compared to the time from the time Tm12 to the time Tm13 in FIG. 9. Since the time from the time Tm22 to the time Tm23 is short, in the time Tm23, the starting temperature difference estimation section 72 estimates the temperature difference between the ECU temperature Te and the fluid temperature Tf as ATef (P3 illustrated in the same view). Thus, in the time Tm23, the starting offset amount setting section 73 sets the starting offset amount Q0, based on the starting temperature difference ΔTef. In the same view, the starting offset amount Q0 is set to be Q01 corresponding to half of the maximum offset amount Qmax.

Then, the offset amount update section 74 gradually increases the offset amount Qoff from the time Tm23 to the time Tm24. In the time Tm24, the offset amount Qoff reaches the maximum offset amount Qmax. The offset amount Qoff is constant in the maximum offset amount Qmax (a curve L27) after the time Tm24.

After the offset amount Qoff reaches the maximum offset amount Qmax, since the hot start is the same as the cold start, hereinafter, the cold start is described, based on FIG. 9 as an example. In the same view, in the time from the time Tm14 to the time Tm18, it is assumed that the cooling effect by wind during travel of the vehicle is obtained. When the driver operates the brake from the time Tm14 to the time Tm15, the ECU temperature Te and the fluid temperature Tf are temporally increased, and when the brake operation is finished, the ECU temperature Te and the fluid temperature Tf are decreased and then return to the temperatures before the brake is operated. The time from the time Tm16 to the time Tm17 is the same as the above description. Detailed description will be given.

Meanwhile, in the time from the time Tm18 to the time Tm19, since the vehicle travels in the low-speed due to, for example, the traffic congestion or the like, it is assumed that the cooling effect by wind during travel of the vehicle is not sufficiently obtained. In the period, the curve L21 illustrates a state where ON and OFF are repeated in short intervals, and the driver operates the brake repeatedly in the short intervals. At this time, since the cooling effect by wind during travel of the vehicle is small, the ECU temperature Te and the fluid temperature Tf increase (curves L23 and L24) while holding the constant temperature difference (the maximum offset amount Qmax). Then, in the time Tm19, when the driver turns OFF the ignition switch IG, the reference temperature acquiring section 71 stores the ECU temperature Te when finishing (P4 illustrated in the same view) the brake ECU 60 in the memory. In addition, in the time from time Tm18 to the time Tm19, small temperature change generated according to ON and OFF of the brake operation is ignored in curves L23 and L24.

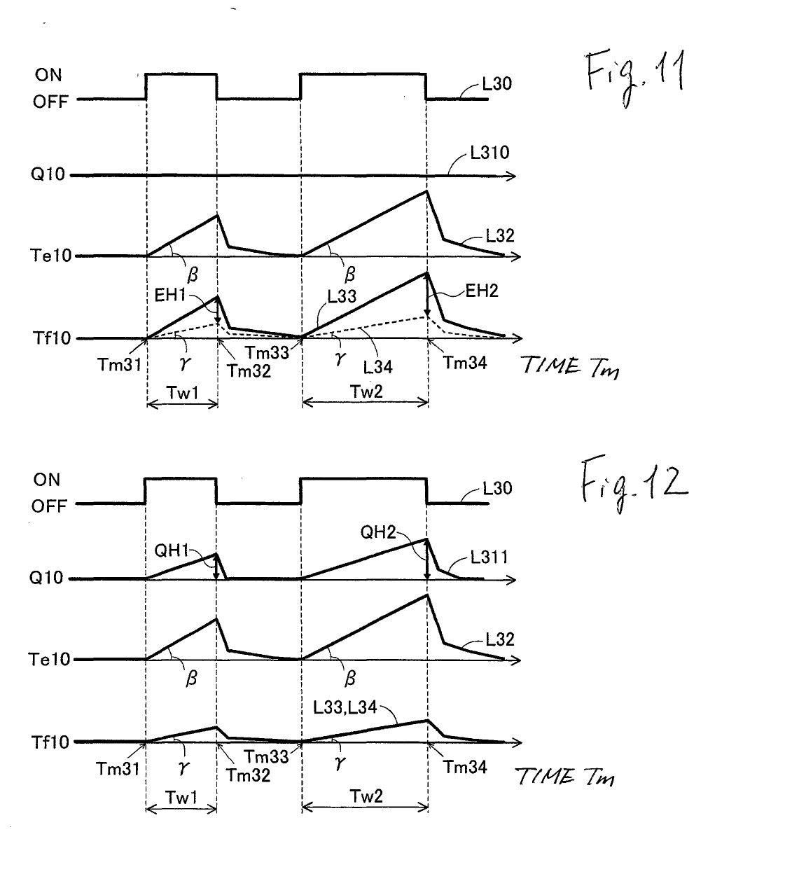

FIGS. 11 to 13 are explanatory views illustrating the estimation of the fluid temperature Tf in a case where the pump 38 is driven (see, the time from the time Tm14 to the time Tm15 and the time from the time Tm16 to the time Tm17 in FIG. 9). FIG. 11 is a timing chart for explaining estimation of the fluid temperature Tf of the embodiment by a comparative example. The lateral axis illustrates the time Tm. A curve L30 illustrates a driving state (ON or OFF) of the pump 38 and a curve L310 illustrates the offset amount Qoff. A curve L32 illustrates a detected value of the ECU temperature Te and a curve L33 illustrates an estimated value of the fluid temperature Tf. A curve L34 illustrates a practical measured value of the fluid temperature Tf. In addition, in the same view, it is assumed that the drive operates the brake in an operation time Tw1 from the time Tm31 to the time Tm32 and an operation time Tw2 from the time Tm33 to the time Tm34.

In the period from the time Tm31 to the time Tm32, the pump 38 is driven according to the brake operation. Thus, the power device (corresponding to “a pump driving section”) for driving the motor 39 is heated in the brake ECU 60 and the pump 38 acts on the fluid in the pressure regulator 43. As a result, the ECU temperature Te and the fluid temperature Tf increase. Then, when finishing the brake operation, the ECU temperature Te and the fluid temperature Tf decrease together, and return to the temperature before the brake is operated (the curves L32 and L34).

However, since an increasing factor of the ECU temperature Te and an increasing factor of the fluid temperature Tf are different from each other, a temperature increasing speed of the ECU temperature Te and a temperature increasing speed of the fluid temperature Tf are different from each other. It is the same for a temperature decreasing speed. The temperature increasing speed and the temperature decreasing speed correspond to “a temperature changing speed”. Thus, as illustrated in FIG. 11, in a case where the offset amount Qoff is not corrected depending on the brake operation, estimated errors (EH1 and EH2) of the fluid temperature Tf are increased.

### Offset Amount Correction Section 77

Then, in the embodiment, the brake ECU 60, when taken as a control block, has the offset amount correction section 77. The offset amount correction section 77 corrects the offset amount Qoff to be increased according to the driving of the pump 38. For example, the offset amount correction section 77 outputs the correction amount QH of the offset amount Qoff, based on an ECU temperature increasing speed β, a fluid temperature increasing speed γ and the operation time Tw, and the offset amount Qoff is corrected to be increased. The ECU temperature increasing speed β is referred to as a temperature increasing gradient of the ECU temperature Te (the reference temperature) when the pressure regulator 43 is operated and illustrates a temperature increasing width per unit time. The fluid temperature increasing speed γ is referred to as a temperature increasing gradient of the fluid temperature Tf when the pressure regulator 43 is operated and illustrates a temperature increasing width per unit time. The operation time Tw is referred to as the operation time from the operation starting of the pressure regulator 43.

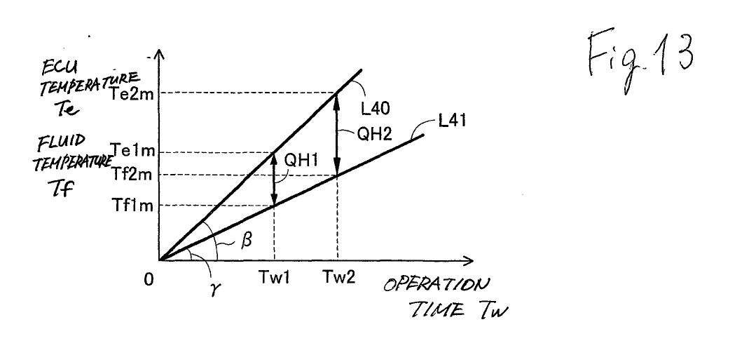

FIG. 12 is a timing chart for explaining the estimation of the fluid temperature Tf according to the embodiment. A curve L311 illustrates the offset amount Qoff which is corrected in the offset amount correction section 77. In addition, the time or the curve on which the same reference numeral as FIG. 11 illustrates the time or the curve illustrated in FIG. 11. As illustrated in the same view, the operation time Tw from the time Tm31 to the time Tm32 is Tw1 and the operation time Tw from the time Tm33 to the time Tm34 is Tw2. The correction amount QH when the operation time Tw is Tw1 is QH1 and the correction amount QH when the operation time Tw is Tw2 is QH2. In addition, when the operation time Tw is Tw1, the maximum value of the ECU temperature Te and the maximum value of the fluid temperature Tf are Te1m and Tf1m, respectively. Similarly, when the operation time Tw is Tw2, the maximum value of the ECU temperature Te and the maximum value of the fluid temperature Tf are Te2m and Tf2m, respectively. In addition, the offset amount Qoff, the ECU temperature Te and the fluid temperature Tf before the pressure regulator 43 is operated are Q10, Te10 and Tf10, respectively.

FIG. 13 is an explanatory view illustrating an example of relationship between the operation time Tw and the correction amount QH of the offset amount Qoff. The lateral axis illustrates the operation time Tw and the vertical axis illustrates the ECU temperature Te and the fluid temperature Tf. A straight line L40 illustrates temporal change of the ECU temperature Te and a straight line L41 illustrates the temporal change of the fluid temperature Tf. The maximum value Te1m of the ECU temperature Te is a multiplied value which is obtained by multiplying the operation time Tw1 and tangent (tan β) of the ECU temperature increasing speed β. Similarly, the maximum value Tf1m of the fluid temperature Tf is a multiplied value which is obtained by multiplying the operation time Tw1 and tangent (tan γ) of the fluid temperature increasing speed γ. Since the error EH1 is the maximum value of the estimated error of the fluid temperature Tf caused by the driving of the pump 38, the correction amount QH1 of the offset amount Qoff can be illustrated in the following Formula 1. Similarly, in the operation time Tw2, the error EH2 of the maximum value Te2m of the ECU temperature Te and the maximum value Tf2m of the fluid temperature Tf is the maximum value of the estimated error of the fluid temperature Tf caused by the driving of the pump 38. Accordingly, the correction amount QH2 of the offset amount Qoff can be illustrated in the following Formula 2.

QH1=Te1m−Tf1m=Tw1(tan β−tan γ) Formula 1

QH2=Te2m−Tf2m=Tw2(tan β−tan γ) Formula 2

In the embodiment, the offset amount correction section 77 corrects the offset amount Qoff to be increased according to the driving of the pump 38. Accordingly, the precision of the estimation of the fluid temperature Tf can be increased in a case where the pump 38 is driven. In the embodiment, the offset amount correction section 77 corrects the offset amount Qoff to be increased, based on the ECU temperature increasing speed β, the fluid temperature increasing speed γ and the operation time Tw from the operation starting of the pressure regulator 43 when the pressure regulator 43 is operated. Thus, the fluid temperature Tf can be estimated according to the temperature increasing gradient of the ECU temperature Te (the reference temperature) and the temperature increasing gradient of the fluid temperature Tf, and the precision of the estimation of the fluid temperature Tf can be improved.

In addition, in the embodiment, the temperature inside the brake ECU 60 (the brake control apparatus) provided in the pressure regulator 43 is acquired as the reference temperature and the fluid temperature Tf inside the pressure regulator 43 is estimated. Accordingly, the fluid temperature Tf can be estimated with high precision regardless of the arrangement of the pressure regulator 43 and the brake ECU 60 (the brake control apparatus) inside the vehicle.

(iii) Others

The invention is not limited to the embodiments described above and illustrated in the drawing. The invention can be embodied by appropriately being changed within a range not departing from the gist thereof. For example, the starting offset amount Q0 can be set by using an outside air temperature sensor, an engine coolant temperature sensor or the like. In addition, the starting offset amount Q0 can be set by using combination of the detected result of the temperature sensor 53 and the detected result of the outside air temperature sensor, the engine coolant temperature sensor or the like.

The braking apparatus 10 can include a stepping force sensor instead of the stroke sensor 52. In this case, in the control of the brake ECU 60, the stepping force of the brake pedal 20 can be used instead of the pedal stroke amount. In addition, they may be used in combination thereof.

The offset amount correction section 77 can correct the offset amount Qoff regardless of the lapsed time Ts from the starting (when starting the brake ECU 60) of the vehicle.

A measurement object of the reference temperature and the fluid receive heat generated according to the operation of the vehicle. Thus, the temperatures of the measurement object of the reference temperature and the fluid are increased depending on the lapsed time from the starting of the vehicle. In addition, since both of specific heat of the measurement object of the reference temperature and the fluid are different from each other, it is considered that the temperature difference between the reference temperature and the fluid temperature is increased depending on the lapsed time from the starting of the vehicle. In this case, when the fluid temperature is estimated by applying a constant offset amount from the starting of the vehicle, the estimation error of the fluid temperature is increased.

Then, in the brake control apparatus according to the above emnodiment, the offset amount with respect to the reference temperature of the fluid temperature is increased depending on the lapsed time from the starting of the vehicle. In addition, the fluid temperature is estimated by applying the offset amount to the reference temperature. Thus, the estimation precision of the fluid temperature can be improved compared to the case where the fluid temperature is estimated by applying the constant offset amount to the reference temperature from starting of the vehicle.

The reference temperature and the fluid temperature are decreased depending on the lapsed time from the stopping of the vehicle, and the temperature difference therewith is decreased. Thus, the temperature difference when starting of the vehicle is different depending the lapsed time from the stopping of the vehicle to the starting of the vehicle. Then, in the brake control apparatus according to the above embodiment, the temperature difference when starting the vehicle is estimated, the starting offset amount is set according to the temperature difference and the offset amount is increased from the starting offset amount. As described above, the fluid temperature is estimated by adding the temperature difference between the reference temperature and the fluid temperature when starting the vehicle. Accordingly, the estimation precision of the fluid temperature can be further improved.

When heat amount given to the measurement object of the reference temperature and the fluid is substantially constant, the temperature difference between the reference temperature and the fluid temperature is substantially constant after a predetermined time is lapsed from the starting of the vehicle. Then, in the brake control apparatus according to the above embodiment, the offset amount is increased to the predetermined maximum offset amount. Accordingly, the estimation precision of the fluid temperature after the predetermined time is lapsed from the starting of the vehicle can be improved.

When driving the pump, the temperature inside the brake control apparatus is increased by the heat of the pump driving section. In addition, the fluid temperature inside the pressure regulator is increased by action of the pump on the fluid. At this time, since temperature increasing factors of the brake control apparatus and the fluid are different from each other, the temperature difference between the reference temperature and the fluid temperature is increased compared to the case where the pump is not driven. Then, in the brake control apparatus according to the above embodiment, the offset amount is corrected to be increased depending on the driving of the pump. Accordingly, the estimation precision of the fluid temperature can be improved when the pump is driven.

Furthermore, according to the brake control apparatus according to the above embodiment, the temperature inside the brake control apparatus which is provided in the pressure regulator is acquired as the reference temperature and the fluid temperature inside the pressure regulator is estimated. Accordingly, the fluid temperature can be estimated with high precision regardless of the arrangement of the pressure regulator and the brake control apparatus inside the vehicle.

What is claimed is:

1. A brake control apparatus comprising:
a reference temperature acquiring unit which acquires a reference temperature correlating with a fluid temperature of a vehicle;
an offset amount update section which increases an offset amount with respect to the reference temperature of the fluid temperature depending on a lapsed time from the starting of the vehicle; and
a fluid temperature estimation section which estimates the fluid temperature by applying the offset amount to the reference temperature.

2. The brake control apparatus according to claim 1, further comprising:
a starting temperature difference estimation unit which estimates a temperature difference between the reference temperature and the fluid temperature when starting the vehicle; and
a starting offset amount setting unit which sets a starting offset amount that is the offset amount when starting the vehicle depending on the temperature difference estimated in the starting temperature difference estimation unit,
wherein the offset amount update unit increases the offset amount from the starting offset amount which is set in the starting offset amount setting unit depending on the lapsed time from the starting of the vehicle.

3. The brake control apparatus according to claim 1,
wherein the offset amount update unit increases the offset amount to a predetermined maximum offset amount depending on the lapsed time from the starting of the vehicle.

4. The brake control apparatus according to any one of claims 1,
wherein the brake control apparatus is applied to a braking apparatus including a pressure regulator which is provided between a master cylinder and a wheel cylinder, and which has a pump for the fluid and which regulates a fluid pressure of the fluid of the wheel cylinder side,
wherein the reference temperature acquiring unit acquires the temperature inside the brake control apparatus,
wherein the fluid temperature estimation unit estimates the fluid temperature inside the pressure regulator, and
wherein the brake control apparatus further comprises:
a pump driving unit which drives the pump; and
an offset amount correction unit which corrects the offset amount to be increased according to the driving of the pump.

5. The brake control apparatus according to any one of claims 1,
wherein the brake control apparatus is provided in a pressure regulator which is provided between a master cylinder and a wheel cylinder, and which regulates the fluid pressure of the fluid of the wheel cylinder side,
wherein the reference temperature acquiring unit acquires the temperature inside the brake control apparatus as the reference temperature, and
wherein the fluid temperature estimation unit estimates the fluid temperature inside the pressure regulator.

6. A brake control apparatus applied to a braking apparatus including a pressure regulator which is provided between a master cylinder and a wheel cylinder, and which has a pump for the fluid and which regulates a fluid pressure of the fluid of the wheel cylinder side, comprising:
a reference temperature acquiring unit which acquires a temperature inside the brake control apparatus as the reference temperature;
a pump driving unit which drives the pump;
an offset amount correction unit which corrects the offset amount with respect to the reference temperature of the fluid temperature to be increased depending on the driving of the pump; and
a fluid temperature estimation unit which estimates the fluid temperature by applying the offset amount to the reference temperature.

7. The brake control apparatus according to claim 6, further comprising:
a starting temperature difference estimation unit which estimates the temperature difference between the reference temperature and the fluid temperature when starting the vehicle;
a starting offset amount setting unit which sets the starting offset amount that is the offset amount when starting the vehicle depending on the temperature difference which is estimated in the starting temperature difference estimation unit; and
an offset amount update unit which increases the offset amount from the starting offset amount depending on the lapsed time from the starting of the vehicle.

8. The brake control apparatus according to claim 7,
wherein the offset amount update unit increases the offset amount to a predetermined maximum offset amount depending on the lapsed time from the starting of the vehicle.

9. The brake control apparatus according to claim 7,
wherein the brake control apparatus is provided in the pressure regulator.
